(19) United States
(12) Patent Application Publication
(10) Pub. No.: US 2026/0036462 A1
(43) Pub. Date: Feb. 5, 2026

(54) METHOD FOR DETERMINING OR MONITORING THE DELIVERY FLOW OF AN ECCENTRIC SCREW PUMP

(71) Applicant: SEEPEX GmbH, Bottrop (DE)

(72) Inventors: Jens MÜLLER, Bochum (DE); Sebastian LEONOW, Bochum (DE); Martin MÖNNIGMANN, Bochum (DE); Christian HANSEN, Hattingen (DE); Johannes SCHULZ, Bottrop (DE)

(73) Assignee: SEEPEX GmbH, Bottrop (DE)

(21) Appl. No.: 19/099,103

(22) PCT Filed: Jul. 7, 2023
(86) PCT No.: PCT/EP2023/068807

§ 371 Date: Jan. 28, 2025

(30) Foreign Application Priority Data
Jul. 29, 2022 (DE) 10 2022 119 147.8

(51) Int. Cl. F04C 14/28; F04C 2/107

(52) U.S. Cl. CPC G01F 25/00; G01P 21/025

(57) ABSTRACT

A method for determining or monitoring the effective delivery flow of an eccentric screw pump that has a rotor rotating eccentrically in a stator at a pump frequency. The effective delivery flow is determined from the difference between an ideal delivery flow and a backflow, which backflow is dependent on at least one gap in the sealing line between rotor and stator. An operating parameter of the pump representing the gap is measured which pulses periodically with the pump frequency, the pulsation amplitude of which is dependent on the state of wear of the rotor and/or of the stator and is related to a tilting of the rotor in the stator. The backflow is calculated repeatedly using a mathematical model in dependence on the measured values for the operating parameter and on predetermined characteristic values of the pump and/or of the medium to be delivered.

The invention relates to a method for determining or monitoring the effective delivery flow (i.e., the flow-through rate) of an eccentric screw pump during operation, wherein the eccentric screw pump has a stator and a rotor that rotates (eccentrically) in the stator at a pump frequency.

In the case of such an eccentric screw pump, the rotor is connected to a drive by way of at least one coupling rod or a comparable element, for example, so that the rotor, i.e., its rotor end rotates eccentrically with reference to the drive axis. The pump has a pump housing connected to the stator on the suction side, for example, which housing is also referred to as a suction housing and generally has a housing opening, for example an inlet opening for the medium to be conveyed. Furthermore, the pump can have a pump housing connected to the stator on the pressure side, for example, which housing is also referred to as a pressure joint in practice. An eccentric screw pump is a pump from the group of rotating displacer pumps, which are used to convey the most varied media and, in particular, high-viscosity liquids in different sectors of industry. The media to be conveyed can also contain high fractions of solids.

The stator consists, for example, of an elastic, preferably elastomer material, and is generally surrounded by a one-piece or multi-piece stator mantle or stator housing. The rotating connection between the drive, i.e., the drive shaft or connecting shaft, on the one hand, and the rotor, on the other hand, which connection at the same time guarantees eccentricity, takes place, for example, by way of the coupling rod arranged in the pump housing. The coupling rod can be connected to the rotor by way of a rotor-side joint, for example, and to a drive shaft or connecting shaft by way of a drive-side joint. Alternatively, however, embodiments having a flexible coupling rod without joints are also included.

The rotor is structured in screw shape, specifically preferably with a relatively great pitch and channel depth as well as a relatively small core diameter. It is arranged eccentrically in the stator, i.e., in the passage opening of the stator, and the stator, i.e., its screw-shaped interior has one convolution more than the rotor. In the case of pumps with clamping, the rotor diameter is greater than the inside stator diameter, i.e., the diameter of the passage opening. However, the invention also covers pumps without clamping. In the case of pumps with clamping, the rotor lies against the inner surface of the stator, i.e., against the inner surface of the passage opening, by way of one or more uninterrupted sealing lines-in the case of an ideal motion. The sealing lines separate conveying spaces from one another, which (continuously) move from the suction side to the pressure side, i.e., from the entry side to the exit side, during the course of rotation of the rotor. The sealing line or sealing lines separate the conveying chambers and seal them off from one another, so that sealing of the suction side of the stator relative to the pressure side takes place.

Eccentric screw pumps of the type described initially are known, for example, from DE 10 2014 112 552 A1, DE 10 2010 037 440 A1, and WO 2009/024279 A1.

Furthermore, a method for determining or monitoring the status of an eccentric screw pump is known from DE 10 2018 113 347 A1, wherein the time progression of an operating parameter of the pump, for example of a pressure or of a pressure difference, is made available, which parameter pulsates periodically with the pump frequency, and the pulsation amplitude of which parameter depends on the status of the eccentric screw pump. In the case of an ideal system, the operating pressure of the eccentric screw pump does not vary with the rotation or rotation frequency of the pump, i.e., an ideal eccentric screw pump is free of pressure pulsations with reference to the operating pressure. In practice, although it is true that eccentric screw pumps are relatively low in pulsations, they nevertheless have certain pressure pulsations that can be attributed to the changing sealing lines during a revolution and to minimal geometry differences of rotor and stator. DE 10 2018 113 347 A1 proceeds from the recognition that the pulsation amplitude of the pressure pulsation depends on the wear of the decisive components of an eccentric screw pump, so that statements regarding the wear state of the pump can be made by way of analysis of the pressure pulsations.

During the use of eccentric screw pumps, in practice there is generally a need to monitor the operation of the pump and to make certain operating parameters available. This relates, for example, to monitoring the actual delivery flow, i.e., the through-flow rate of an eccentric screw pump. For this purpose, in practice, special through-flow sensors are used, with which the delivery flow can be measured directly. The high investment costs for such through-flow sensors are disadvantageous, so that for many cases of use, they cannot be used economically. For this reason, it has already been proposed to determine the delivery flow merely by approximation, on the basis of the pump characteristic line and with knowledge of the current pump speed of rotation. Since this determination of the delivery flow by approximation is based on the pump characteristic line, which is generally stated by the pump manufacturer and relates to a pump when new, the delivery flow estimate in this method of procedure becomes increasingly inaccurate with increasing wear of the pump components. The actual state of the pump components cannot be taken into consideration in this delivery flow estimate. Therefore a decreasing delivery flow, for example, can remain unnoticed and thereby lead to shutdown of the process. This is where the invention takes its start.

Proceeding from the previously known state of the art and the disadvantages described, the invention is based on the task of indicating a method that allows improved determination of the actual delivery flow, without using dedicated through-flow sensors, specifically, in particular, taking into consideration the actual wear of the rotor and/or stator and the geometry changes connected with this.

To accomplish this task, the invention teaches a method for determining or monitoring the (wear-dependent) effective delivery flow of an eccentric screw pump during operation,
wherein the eccentric screw pump has a stator and a rotor that rotates in the stator at a pump frequency,
wherein the effective delivery flow is determined from the difference of an (ascertained) ideal delivery flow (for example of a pump that is like new) and a backflow that is directed counter to the ideal delivery flow, which backflow is dependent on at least one gap in the sealing line between rotor and stator,
wherein an operating parameter of the pump, which parameter represents the gap and thereby the backflow, is measured (or, alternatively, made available), which parameter pulsates periodically with the pump frequency, and the pulsation amplitude of which parameter is dependent, on the one hand, on the wear state of the rotor and/or of the stator, and, on the other hand, is related to a tilt of the rotor in the stator, which tilt influences the gap and thereby the backflow,
wherein the backflow and from it, the effective delivery flow is repeatedly calculated, using a mathematical model, as a function of the measured values for the operating parameter and of (fixedly) predetermined characteristic values of the pump, for example values stored in memory, and/or of the medium to be delivered.

Preferably, at least an operating pressure of the eccentric screw pump is made available or measured as an operating parameter, and the pulsation amplitude of the pressure pulsation is evaluated. Preferably, measurement or determination of a pressure difference is particularly possible as the operating pressure, specifically preferably the difference between the pressure on the pressure side of the stator, on the one hand, and the pressure on the suction side of the stator, on the other hand. Alternatively, a different operating parameter can also be used, for example a torque, which also shows pulsations.

The ideal delivery flow can be determined in advance by means of calculations, for example. Alternatively, the ideal delivery flow can be determined previously by means of measurement, for example by means of measurement in a test field.

The invention proceeds, at first, from the recognition that the effective or actual delivery flow in a pump can be determined, in practice, from the difference of an ideal delivery flow that has been calculated, for example, and a backflow that is directed counter to the ideal delivery flow, which backflow results from a non-perfect seal or sealing line between rotor and stator and thereby depends on at least one gap in the sealing line between rotor and stator. The gap, i.e., the backflow depends, in this regard, on the pressure difference, i.e., the difference of the pressure-side pressure and the suction-side pressure. The pressure difference leads to an (approximately) constant tilt of the rotor, for example about a Y axis, which influences the backflow. This is because the tilt of the rotor raises the rotor up from the stator and thereby produces a sickle-shaped gap in the sealing line.

Aside from such a constant or “static” tilt (for example about a Y axis), which results from a static pressure difference, varying (periodic) tilts of the rotor occur, for example about the X axis. These change the volume of the cavity, which is open toward the pressure side, and pressure pulsations or pulsations in the pressure difference result from this. The periodic tilt of the rotor (about the X axis) directly leads to periodic changes in the pressure difference, i.e., the pulsation amplitude (for example of the pressure pulsations) is connected to the tilt of the rotor and thereby to the size of the gap, and the latter in turn is connected to the backflow. Consequently, the backflow can be modeled accordingly by way of the evaluation of the pressure pulsations, i.e., of the pulsation amplitude of the pressure pulsations, and thereby the actual delivery flow can be determined, using a mathematical model, taking into consideration the measured pressure difference and, in particular, the pulsation amplitude of the pressure pulsations that was determined from this.

In this regard, the fact that the pulsation amplitude (i.e., the “peak-to-peak value” of the pressure difference) is significantly dependent on the wear of the rotor and/or of the stator of the eccentric screw pump is particularly interesting. Consequently, according to the invention, not (only) the pressure pulsations that might already occur in the new state of the pump are included in the analysis using the mathematical model, but rather the wear-dependent pressure pulsations that actually occur, i.e., the wear-dependent pulsation amplitude is/are also included, so that in fact, the gap in the sealing line between rotor and stator, which becomes larger with increasing wear, is taken into consideration using the mathematical model.

In this way, the actual delivery flow of an eccentric screw pump can be monitored, in total, using a very simple sensor system, because according to the invention, no measurement of the delivery flow takes place using a pressure sensor, but rather a computational determination using a mathematical model takes place, in which model, in turn, measurement values are included, which can, however, be made available in a simple manner, for example in the form of measured pressure values and, in particular, a pressure difference between pressure side and suction side of the pump. Alternatively, other measurement values, for example torque measurement values can be used. Consequently, the determination of the delivery flow takes place in the manner of a “virtual sensor” on the basis of advantageous measurement values and taking into consideration the actual rotor/stator wear and the related changes in geometry. Thus, reliable determination and monitoring of the delivery flow, i.e. a delivery flow estimate become(s) possible even with simple, efficient means, with which the process reliability can be increased and down times can be minimized.

Preferably, in addition to the operating parameter described, for example the pressure difference, the speed of rotation of the pump or of the rotor is also measured or made available in some other manner, and taken into consideration in the calculation using the mathematical model.

In particular, the geometry parameters of the pump, i.e., the geometry parameters of rotor and/or stator, are stored in memory and taken into consideration in the calculation as fixed predetermined characteristic values of the pump. Furthermore, characteristic values of the medium to be conveyed can be taken into consideration. It is understood that for a specific pump type and, if applicable, also for a specific application, adaptation of the mathematical model takes place, in that the decisive characteristic values are determined experimentally and/or theoretically in advance, and integrated into the system in the sense of a calibration.

Particularly preferably, the calculation in the manner described is based on measurement and analysis of the operating pressure, for example the pressure difference, since the pulsation amplitude of the pressure pulsation is significantly dependent on the wear of the decisive components, and therefore wear-dependent monitoring of the delivery flow is possible.

Fundamentally, the invention also comprises detection and analysis of the time progression of other operating parameters of a pump, which pulsate periodically with the pump frequency, and the pulsation amplitude of which is dependent on the state of the eccentric screw pump. Such an operating parameter can be made available, in the manner described, by means of a measurement, i.e., it can be measured. Alternatively, it is also possible not to measure the operating parameter directly, in each instance, but rather to calculate it from directly measured values. Thus, as an alternative to the operating pressure as the operating parameter, for example, the torque or the motor current of the pump drive can also be made available or used. In this case, the pulsation amplitude of the torque pulsation or motor current pulsation is determined. Thus, for example, the wear at the stator and/or rotor, in the case of an eccentric screw pump, typically leads not only to pressure pulsations, but also to pulsation-like changes in the torque of the pump, and for this reason the torque pulsation can be used as an operating parameter. Furthermore, the pulsation-like changes in the torque lead to a pulsating power consumption or current consumption, so that the power consumption or current consumption can also be used as an operating parameter. Likewise, wear-related changes in the rotor/stator geometry of the pump also lead to periodic or pulsating changes in the structure-borne sound, so that the structure-borne sound can also be used as an operating parameter.

The invention falls back, in this regard, on the recognitions of DE 10 2018 113 347 A1. Furthermore, the invention is based, however, on the surprising recognition that the pulsations or pulsation amplitudes that should primarily be analyzed are directly related to the tilt of the rotor in the stator, which tilt in turn is connected to the gap in the sealing line between rotor and stator and thereby to the backflow, so that the backflow and thereby the delivery flow of the pump can be modeled by way of the pressure pulsations.

The invention relates not only to the method described, but rather also to a monitoring device for an eccentric screw pump, which device comprises means that are suitable for carrying out the method described. Consequently, the monitoring device comprises suitable hardware that is set up with corresponding software for carrying out the method described. This hardware comprises a computer, for example. Supplementally, the monitoring device can comprise at least one sensor for measuring the operating parameter. In a preferred further development, the monitoring device comprises at least one pressure sensor for measuring an operating pressure. Several pressure sensors can also be provided, for example a pressure sensor for measuring the operating pressure on the pressure side of the stator and/or a pressure sensor for determining the operating pressure on the suction side of the stator. If applicable, a sensor on the pressure side can also be sufficient for determining the pressure difference, specifically, for example, if the pressure on the suction side essentially corresponds to the ambient pressure or is close to the ambient pressure.

The invention furthermore relates to an eccentric screw pump that is equipped with such a monitoring device or is connected to such a monitoring device.

Finally, the invention also relates to a computer program that comprises commands that bring about the result that the monitoring device carries out the method described.

In the following, the invention will be explained in greater detail using drawings that merely show an exemplary embodiment. The figures show:

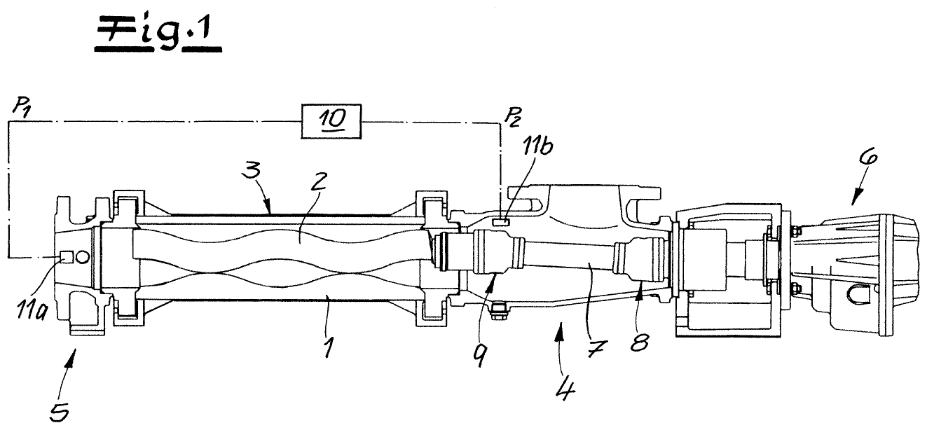

FIG. 1 an eccentric screw pump having a device for determining or monitoring the effective delivery flow,

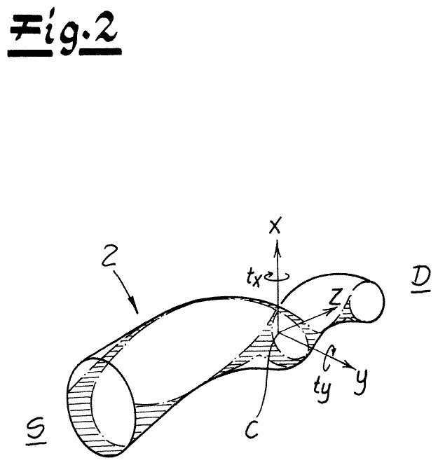

FIG. 2 the geometry of a rotor of an eccentric screw pump according to FIG. 1,

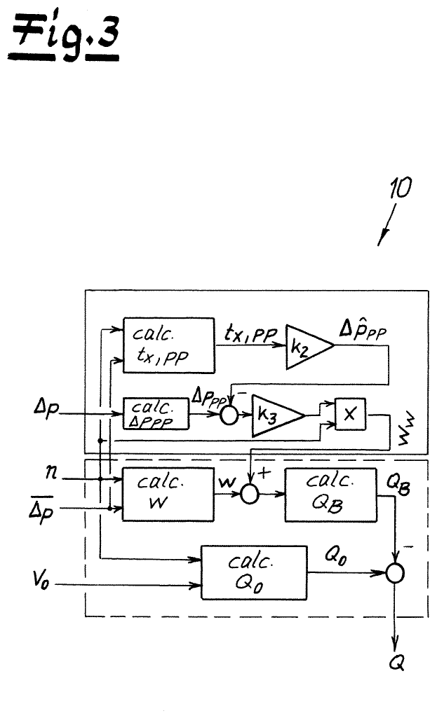

FIG. 3 a schematic representation of the method according to the invention for determining or monitoring the effective delivery flow of the eccentric screw pump,

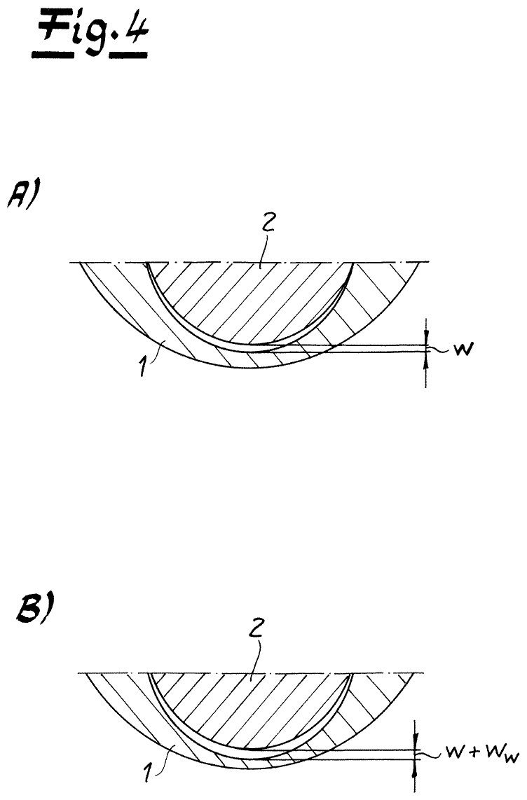

FIG. 4a, b in each instance, a partial cross-section through the rotor according to FIG. 2.

In FIG. 1, a usual eccentric screw pump is shown, which has a stator 1 composed of an elastic material and a rotor 2 that rotates in the stator 1, wherein the stator 1 can be surrounded by a stator mantle 3. Furthermore, the pump has a suction housing 4 as well as a connecting piece 5, which is also referred to as a pressure joint 5. The pump furthermore has a pump drive 6, which acts on the rotor 2 by way of a coupling rod 7. The coupling rod 7 is connected to the drive 6, i.e., to a drive shaft by way of a drive-side coupling joint 8, and to the rotor 2 by way of a rotor-side coupling joint 9.

In the exemplary embodiment, a pump is implemented with clamping, i.e., the rotor 2 lies against the inner surface of the passage opening of the stator 1 by way of multiple uninterrupted sealing lines—in the case of an ideal motion. These sealing lines are indicated with hatched lines on the surface of the rotor 2 in FIG. 2.

In the exemplary embodiment shown, a pressure sensor 11a for determining the operating pressure is provided on the pressure side D, in the region of the pressure joint 5, on the one hand, and a pressure sensor 11b for determining the operating pressure on the suction side S is provided in the region of the suction housing 4, on the other hand. The eccentric screw pump 10, i.e., the sensors 11a, 11b is/are connected to a monitoring device 10 with which the delivery flow Q of the eccentric screw pump can be determined or monitored during operation.

In this regard, however, no direct measurement of the delivery flow Q by way of a through-flow sensor takes place, but rather a system having a “virtual” sensor is implemented, which is based on a delivery flow estimate or delivery flow determination using a mathematical model, taking into consideration a simplified measurement of an operating parameter, namely the operating pressure of the pump. In this regard, the invention makes uses of the relationship between the delivery flow Q of the pump and certain phenomena and relationships that will be discussed in greater detail below.

In an eccentric screw pump, the actual, effective delivery flow Q results from the difference of an ideal delivery flow Q₀ and a backflow Q_{B} directed counter to the ideal delivery flow Q₀, wherein the backflow depends on at least one gap in the sealing line between rotor and stator. The ideal delivery flow Qo can be determined by calculations, for example, from the pump speed of rotation n and the delivery volume V₀:

$$Q = {V}_{0} \times n - {Q}_{B} .$$

The analysis of the backflow Q_{B} is of particular importance within the scope of the invention.

In the case of an eccentric screw pump, the pressure difference Δp, i.e., the difference between the (operating) pressure p₁ on the pressure side D and the (operating) pressure p₂ on the suction side S, which difference is to be monitored by means of measurement technology, leads to a constant tilt t_{y} of the rotor about the Y axis shown in FIG. 2. This constant tilt t_{y} produces a gap w that in turn brings about a backflow Q_{B}, wherein this gap w and thereby the backflow Q_{B} are essentially dependent on the pressure difference Δ⁻p averaged over a period.

Furthermore, periodic pressure differences between the pressure side D and the suction side S occur, which result from a periodic tilt tₓ of the rotor about the X axis shown in FIG. 2. The tilt tₓ pulsates at the rotation frequency (i.e., at twice the rotation frequency, since two chambers open per revolution) of the rotor 2 and at a pulsation amplitude for the tilt, which is also referred to as a “peak-to-peak value” of the tilt t_{x,pp}. The periodic tilt tₓ results from periodic changes in the pressure difference Δp, so that pulsations in the pressure difference Δp and, in particular, also the pulsation amplitude Δpₚₚ of the pressure difference are directly related to the pulsation amplitude t_{x,pp} of the tilt tₓ.

According to the invention, the effective delivery flow Q can now be modeled mathematically, specifically taking into consideration measured values for the pressure difference Ap and, in particular, the pressure pulsation of the pressure difference. In this regard, the fact that this pulsation amplitude, i.e., the peak-to-peak value Δpₚₚ in the pressure difference is sensitively dependent on the wear state of rotor and/or stator, so that the wear of rotor and/or stator, which increases during the course of operation, can be taken into consideration directly during the course of modeling. In this regard, reference is made to the method schematic according to FIG. 3.

In the lower box in FIG. 3, outlined with a broken line, one can see the simple modeling of the backflow Q_{B} and thereby of the actual delivery flow Q on the basis of a measurement of the averaged pressure difference Δ⁻p, which is directly related to the size of the sickle-shaped gap w in the sealing line between rotor 2 and stator 1, specifically on the basis of the tilt t_{y} of the rotor about the Y axis, produced on the basis of the pressure difference Ap, which tilt leads to the gap w. In this regard, in FIG. 3 (bottom), “calc. w” represents the calculation of the sickle-shaped gap w, “calc. Q_{B}” represents calculation of the backflow or back stream Q_{B}, and “calc. Q₀” represents the calculation of the ideal delivery flow Q₀. This gap w is shown in FIG. 4a.

In the upper part of FIG. 3, in the box shown with a solid line, the influence of the periodic tilt tₓ of the rotor about the X axis and thereby the pressure pulsation Δpₚₚ is shown, which significantly depends on the wear of rotor and/or stator, so that the wear of rotor and/or stator flows in directly, by way of the modeling shown in the upper part. Thus, it is possible to determine the pulsation amplitude Δpₚₚ of the pressure pulsation, i.e., the “peak-to-peak value” of the periodically changing pressure difference, from the measurement of the pressure difference Δp (calc. Δpₚₚ). Since, however, pressure pulsations already occur in the new state of the pump, independently of wear, a wear-independent pulsation amplitude (Δ\hat{p}ₚₚ) is determined by calculations, by way of the “peak-to-peak value” of the tilt (calc. t_{x,pp}), and deducted from the measured pulsation amplitude Δpₚₚ in the sense of standardization. In any case, the contribution of the wear-dependent gap w_{w} to the gap w in the sealing line can be modeled and taken into consideration by way of the determination of the pulsation amplitude (cf. FIG. 4b). The wear-dependent component w_{w} of the gap shown in FIG. 4b consequently results from the following equation, in accordance with the diagram in FIG. 3:

$${w}_{w} = {k}_{3} n ( Δ {p}_{pp} - {k}_{2} {t}_{x , pp} )$$

wherein t_{x,pp} and thereby Δ\hat{p}ₚₚ are determined purely by calculations. The gap w_{w} can consequently be calculated repeatedly on the basis of the continuing measurement of the pressure pulsations.

In this way, a virtual sensor is created, which is based on an adaptive determination or monitoring of a representative operational value, in this case the pressure difference Δp. By means of repeated calculation of the wear-dependent gap component w_{w} as a function of the pressure pulsations, adaptive adaptation to the wear state takes place. The invention is based, in this regard, on the important recognition that the pressure pulsations to be measured are directly related to the tilt of the rotor, which pulsations bring about a gap that influences the backflow. Since the pressure pulsations in turn are wear-dependent, it is possible to take the wear into consideration directly in the modeling, by way of the analysis of the pressure pulsations.

The invention allows improved monitoring and, for example, also maintenance predictions, under the aspect of “predictive maintenance.”

1. A method for determining or monitoring an effective delivery flow (Q) of an eccentric screw pump during operation,
wherein the eccentric screw pump has a stator (1) and a rotor (2) that rotates eccentrically in the stator (1) at a pump frequency,
wherein the effective delivery flow (Q) is determined from a difference of an ideal delivery flow (Q₀) and a backflow (Q_{B}) that is directed counter to the ideal delivery flow (Q₀), which backflow is dependent on at least one gap (w) in a sealing line between the rotor (2) and stator (1), the method comprising the steps of:
measuring an operating parameter of the pump, which parameter represents the at least one gap and thereby the backflow (Q_{B}), which parameter pulsates periodically with a pump frequency, wherein a pulsation amplitude of the operating parameter is dependent, on a wear state of the rotor and/or of the stator, and, is related to a tilt of the rotor (2) in the stator (1), which tilt influences the at least one gap (w) and thereby the backflow (Q_{B}),
and repeatedly calculating the backflow (Q_{B}) and from it, the effective delivery flow (Q), using a mathematical model, as a function of the measured values for the operating parameter and of predetermined characteristic values of the pump and/or of a medium to be delivered.

2. The method according to claim 1, wherein an operating pressure of the pump or of the medium to be conveyed, in or at the pump, is used as the operating parameter.

3. The method according to claim 2, wherein a parameter difference in the form of a pressure difference measured as a difference (Δp) between a pressure (p1) on the a pressure side (D) of the stator and a pressure (p₂) on a suction side (S) of the stator (1) is used as the operating parameter.

4. The method according to claim 1, wherein in addition, a speed of rotation (n) of the pump or of the rotor (2) is measured or made available, and flows into the calculation using the mathematical model.

5. The method according to claim 1, wherein geometry parameters of the pump are used as the predetermined characteristic values of the pump.

6. The method according to claim 3, wherein from the measured parameter difference, an average value averaged over at least one period is determined as a static pressure difference (Δ⁻p), and a pulsation amplitude (Δpₚₚ) is determined as a dynamic pressure difference.

7. The method according to claim 1, wherein a wear-dependent pulsation amplitude (Δpₚₚ) determined from the measurement of the parameter difference, for example pressure difference, is corrected, taking into consideration a nominal pulsation amplitude (Δ\hat{p}ₚₚ), which is based on the pump in the a new state.

8. A monitoring device for an eccentric screw pump, comprising means that are suitable for carrying out the method according to claim 1.

9. The monitoring device according to claim 8, comprising at least one sensor (11a, 11b) for measuring the operating parameter.

10. The monitoring device according to claim 9, wherein the at least one sensor comprises at least one pressure sensor configured for measuring an operating pressure, the at least one pressure sensor comprising at least one first pressure sensor (11a) configured for measuring the pressure (p₁) on the pressure side (D) of the stator and/or at least one second pressure sensor (11b) configured for determining the pressure (p₂) on the suction side (S) of the stator (1).

11. A computer program comprising commands that when installed in a monitoring device carries out the method according to claim 1.

12. An eccentric screw pump having a monitoring device according to claim 8.
